(19) United States
(12) Patent Application Publication
(10) Pub. No.: US 2024/0418155 A1
(43) Pub. Date: Dec. 19, 2024

(54) POWER PLANT CYCLE FOR A NEW RENEWABLE ENERGY OR OTHER HEAT SOURCE FACILITATED BY A SUPERSONIC SHOCK WAVE COMPRESSOR APPARATUS

(71) Applicant: Calvin E. Phelps, Sr., Easton, PA (US)

(72) Inventor: Calvin E. Phelps, Sr., Easton, PA (US)

(21) Appl. No.: 18/522,482

(22) Filed: Nov. 29, 2023

Related U.S. Application Data
(60) Provisional application No. 63/466,492, filed on May 15, 2023.

(51) Int. Cl. F02C 6/00; F02C 1/02; F03G 3/00; H02K 7/18

(52) U.S. Cl. CPC F02C 6/00; F02C 1/02; F03G 3/096; H02K 7/183; F05D 2220/76

(57) ABSTRACT

A new power plant cycle that does not condense the vapor leaving the turbine facilitated by an innovative vapor compression apparatus to repressurize the vapor with heat input to the cycle from a new renewable energy or other heat source. The new cycle can be used in place of the conventional low efficiency Rankine cycle to provide economical production of electricity. Using the cycle with heat input from a fossil fuel would reduce air pollution from this source to a fraction of current emissions.

### CROSS-REFERENCE TO RELATED APPLICATION

This application claims benefit of U.S. Patent Application No. 63/466,492, filed on May 15, 2023, the disclosure of which is hereby incorporated by reference in its entirety to provide continuity of disclosure to the extent such a disclosure is not inconsistent with the disclosure herein.

### FIELD OF THE INVENTION

The disclosed novel power plant cycle using a novel renewable energy, or other heat source, without condensing the vapor leaving the turbine is facilitated by an innovative vapor compression apparatus to repressurize the vapor; thereby, facilitating a novel method for the production of electricity. The other heat source may include, but is not limited to renewable energy, fossil fuels, nuclear energy, geothermal sources, solar heat, waste heat, electric heat, or other low temperature heat sources.

A conventional stationary power plant using the Rankine cycle loses about 50% plant efficiency due to heat rejection to the environment when the vapor leaving a turbine is condensed so that liquid pumps can restore pressure to the cycle. Conversely, in one embodiment of the present invention, the vapor leaving the turbine is not condensed and the compression apparatus restores vapor pressure to the cycle. Since the compression apparatus minimizes consumption of auxillary power, net power plant output is further increased. The power savings advantage offered by this novel invention may be applied in other applications such as carbon capture and storage (CCS) applications.

Since the power plant cycle of the present invention does not condense vapor. most of the equipment and piping used in the conventional power plant Rankine cycle would not be required, including the condenser system and cooling tower. Also, less complex boiler designs and high temperature materials would be required. Finally, power plants using the novel power plant cycle of the present invention can be independently located from water sources for condenser coolant.

Currently, supersonic shock wave compressors compress the combustion air for in-flight supersonic and hypersonic aircraft based on Ramjet technology. When the aircraft exceeds the speed of sound and the flow of incoming combustion air to the engines exceeds supersonic velocity, the impinging air onto the inlet cowl and cone or wedge creates shock waves; thereby, additively compressing the air with each of the oblique shock waves and when encountering subsonic velocity air flow after a normal shock wave at the throat prior to entering the downstream flow. Advancements in these aircraft engine designs now include adjustable cowls and more complex cone or wedge surfaces to generate multiple oblique shock waves, along with axially adjustable cones or wedge angles to optimize production of oblique sonic waves and compression. Since these aircraft do not use a rotary compressor, the magnitude of compression is dependent on the entering air velocity, which must be greater than the speed of sound (c), or Mach number (M) greater than 1. Higher air inlet Mach number velocities produce higher compression.

In one embodiment, the compression apparatus disclosed for the power plant cycle of the present invention includes a conventional supersonic wave compressor (SSWC) which is currently used to compress combustion air in supersonic aircraft engines while the aircraft is flying. A unique aspect of the present invention is that to facilitate compression by the SSWC in a stationary power plant, a choke valve or other conventional velocity choking device is located upstream of the SSWC to transition the gas flowing at subsonic velocity to supersonic velocity entering the SSWC to simulate aircraft speed greater than Mach 1. The choke valve uses a cylindrical plug with a cage around the cylindrical plug that includes slotted or round ports. Also, in one embodiment of the present invention, the plug travel is controlled to provide port openings that can be used to control choke velocity in relation to gas flow, thereby, continuously transitioning the gas entering the SSWC to supersonic velocity. Another unique aspect of the present invention is that if one compression apparatus set, comprised of a choke valve, connecting divergent pipe, and a SSWC does not adequately compress the gas to the desired pressure, additional sets can be installed in series, as necessary.

The heat input to the cycle is from a new renewable energy consisting of pump heat of compression. Other renewable energy or conventional source heat inputs can be used as well.

A still another unique aspect of the present invention is that power plant cycles in stationary power plants with supersonic shock wave compression would provide economical production of electricity and air pollution from fossil fuel plants would be reduced to a small fraction of that currently produced.

### BACKGROUND OF THE INVENTION

In 2008, the U.S. Department of Energy partnered with Ramgen Power Systems and the Dresser-Rand business in a co-funding project to adapt Ramjet flight-based SSWC to CCS applications requiring large CO₂ compression ratios to increase the pressure near atmospheric pressure to about 2200 psia. Supersonic shock wave compression was proven successful by the project with the use of a specially designed rotating impeller to create shock waves in the stream of CO₂ flowing in at subsonic velocity which compressed the air from about 20 psia to 240 psi, or at a 12:1 compression ratio. The test resulted in compression power savings and in beneficial heat recovery, but the rotating impeller consumed a significant amount of auxiliary power. Therefore, it would be desired if the compression apparatus did not use a rotating impeller to consume power. Furthermore, it would be desired if the CCS would be more economically viable by using a compression apparatus downstream of the stationary Ramgen compressor, or a conventional compressor, to enable compression.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is a flow diagram depicting the power plant cycle, according to one embodiment of the present invention;

FIG. 1A is a flow diagram depicting an alternate startup loop, according to one embodiment of the present invention;

FIG. 2 is a P-H diagram depicting the power plant cycle, according to one embodiment of the present invention; and

FIG. 2A is a P-H diagram depicting the power plant cycle with the alternate startup loop, according to one embodiment of the present invention.

### BRIEF SUMMARY OF THE INVENTION

In one embodiment of the present invention, the power plant cycle (C), using a new renewable energy or other available heat source without vapor condensation leaving the turbine, is facilitated by a novel vapor compression apparatus to repressurize the vapor. The new renewable energy source is provided by pump heat of compression (HOC). In particular. the novel compression apparatus consists of a supersonic shock wave compressor (SSWC). As discussed above, since the SSWC requires the entering air to be at or above supersonic velocity, the SSWC is adapted to stationary service by including a velocity choking device to provide supersonic velocity vapor to the SSWC to facilitate compression.

In general, the power plant cycle consists of a startup loop and a power loop. The startup loop portion of the power plant cycle consists of two streams of liquid carbon dioxide (CO₂) to provide mass flow, a starting pressure, and heat input from pump HOC to the power loop. However, it is to be understood that any suitable heat trapping gas that performs similarly to CO₂ can also be used. The first stream includes a pump receiving liquid from a tank storing CO₂ at saturation pressure, which then elevates the pressure to a supercritical pressure liquid to produce HOC for heat transfer to the power loop in an indirect heat exchanger located upstream of the compression apparatus. The second stream includes a second pump receiving CO₂ from the storage tank, which then elevates the pressure to a supercritical pressure just above critical pressure for entering the power loop and the indirect heat exchanger to absorb heat from the first stream; thereby, providing a preliminary starting mass flow, pressure, and temperature to the compression apparatus. The startup loop portion of the power plant cycle continues increasing the mass flow to a vapor compression apparatus located within the power loop until compression is facilitated within the vapor compression apparatus and a desired base load is achieved by the cycle.

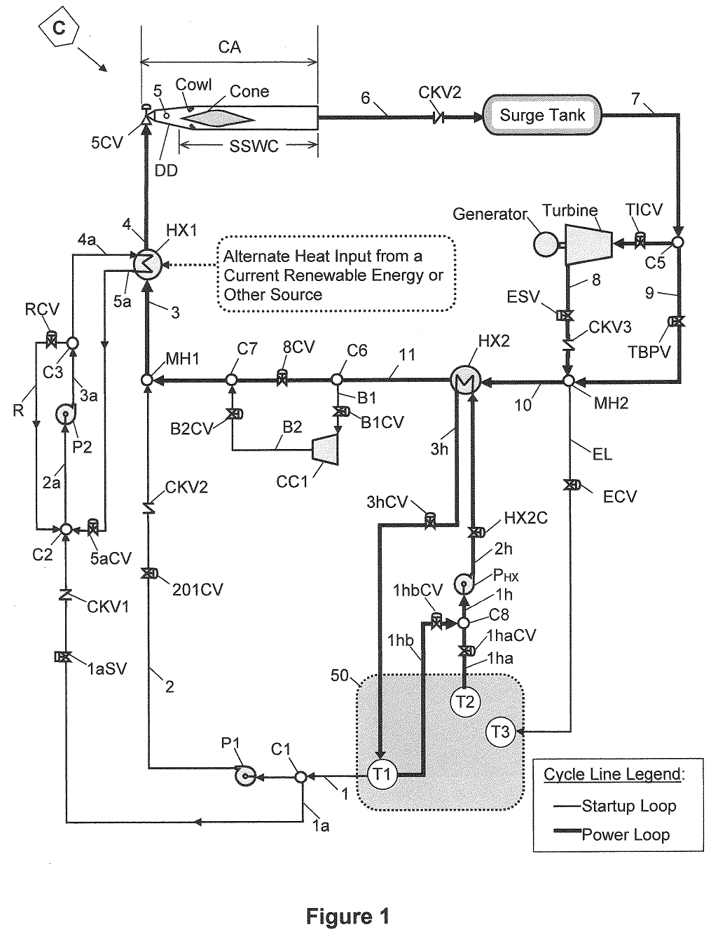

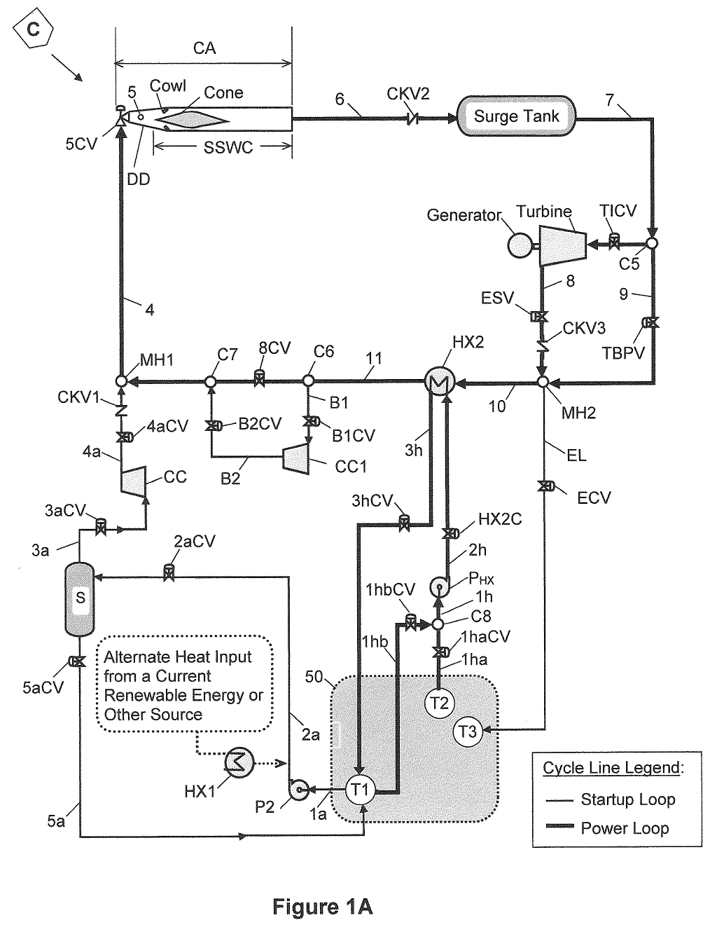

The power loop portion of the power plant cycle starts at a mix header in which the vapor leaving the turbine is combined with the second stream of the startup loop portion. The power loop portion includes the vapor compression apparatus, one or more surge tanks, a turbine-generator set, and indirect heat exchangers. The vapor compression apparatus includes a velocity choking device with an outlet divergent duct connected to the inlet of the SSWC. To ensure that the pressure reduction required to control choke velocity does not create a low temperature vapor or subcritical mixture entering the SSWC, the preliminary enthalpy and pressure provided by the startup loop portion second stream to the power loop velocity choking device should be at values to avoid these conditions. Before the compressor apparatus facilitates compression in the power loop, a conventional compressor in the startup loop restores pressure to the cycle equivalent to the choking device pressure reduction to control Mach 1 throat velocity. After the compressor apparatus compresses vapor as designed, the conventional compressor CC1 can be transitioned from service by opening 8CV and closing B1CV and 2CV (FIGS. 1 and 1A).

In another embodiment of the present invention, an alternate startup loop portion includes pump HOC to provide saturated vapor to a conventional compressor CC1 to elevate the pressure and temperature to avoid creating a saturated mixture or low temperature vapor entering the SSWC after pressure reduction by the velocity choking device.

In another embodiment of the present invention, an alternate for the startup loop portion includes starting with a CO₂ vapor and not liquid CO₂. The vapor source quality, including purity and particulate content, can be found in manufacturing plants that produce liquid CO₂ as a product for transport. The vapor can be conditioned to the required inlet pressure, temperature, and enthalpy of the power loop; thereby, avoiding liquid CO₂ for startup, except for the cooling or heating portion for the vapor leaving the turbine.

To heat the CO₂ vapor leaving the turbine, the vapor leaving the turbine is taken from tank T1 through line 1hb and control valve 1hbCV, connection C8, and line 1h to P_{HX}, in which the pressure is elevated from 900 psia to about 2000 psia to provide a 10° F. approach temperature to the vapor leaving the turbine. The heating CO₂ temperature is reduced in HX2 so that isenthalpic pressure reduction by control valve 3hCV creates a saturated liquid for return to tank 1 through line 3h and control valve 3hCV.

One or more surge tanks are located between the compression apparatus and turbine to maintain a sufficient volume of CO₂ to minimize pressure fluctuations, and to minimize large pressure and thermal shocks to the turbine in the event of compression loss. In the event of a power plant trip, an emergency operated shut-off valve located downstream of the turbine is quickly closed to isolate the turbine with the surge tank (ST). If external or stored power is unavailable during a power plant trip, emergency backup power should be included for the emergency shut-off valve.

Flow is routed from the surge tank to the turbine, which isentropically expands the vapor to produce electricity with a shaft-connected generator. The vapor leaving the turbine is routed through an indirect heat exchanger for controlling the temperature and then to the mixing header to recombine with the first stream of the startup loop portion. The heat exchanger controls the vapor temperature, in conjunction with the startup loop portion, to near starting conditions entering the compression apparatus. The startup loop portion of the power plant cycle continues to charge the power loop, as discussed earlier, until a desired base load or full load is established; after which, the startup loop portion can be placed in standby mode, since the compression apparatus sustains a desired power loop pressure.

A turbine bypass is provided to ensure that vapor does not enter the turbine until the inlet vapor conditions are suitable. Using the turbine bypass in parallel with turbine operation also provides flow control and compression stability, since maintaining a recirculation mass flow provides more flow to the compression apparatus and increases the compression control range.

### Detailed Description of the Invention

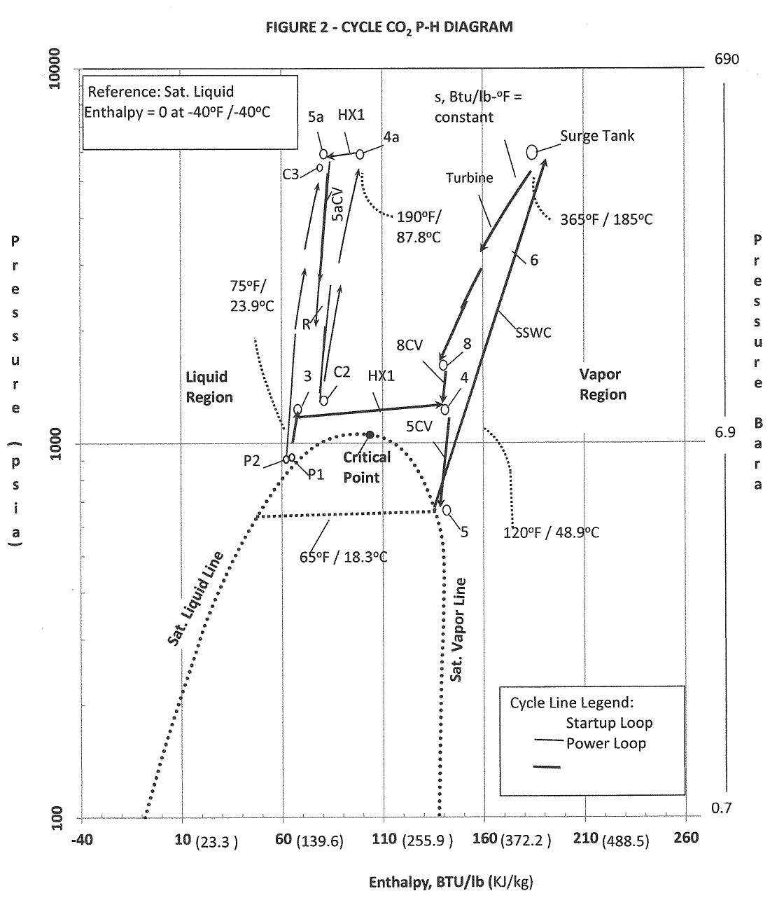

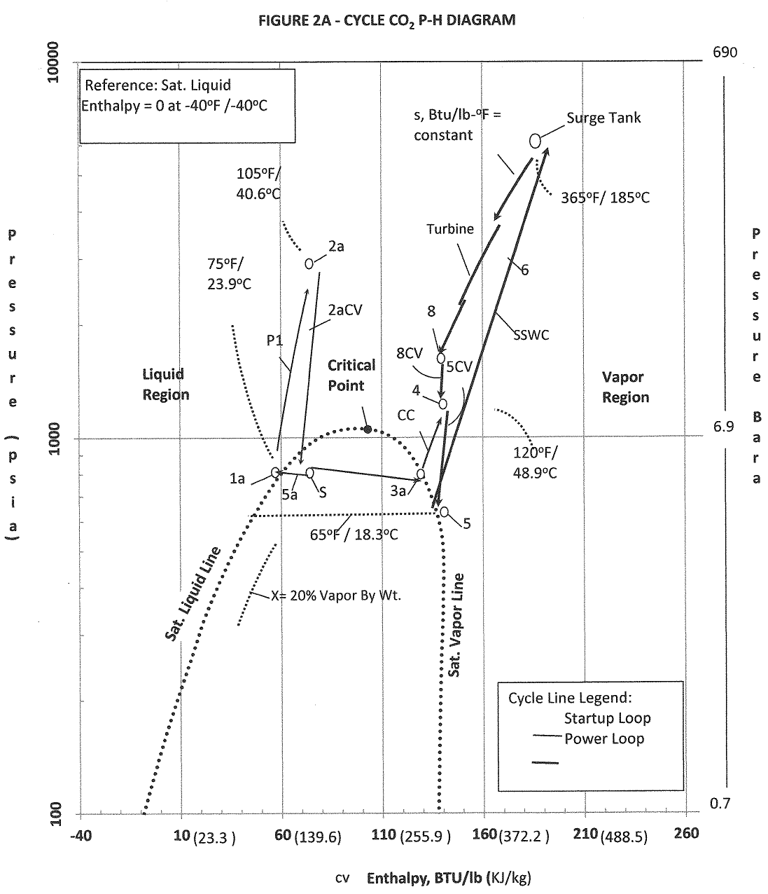

Now attention is directed to FIGS. 1 and 2 which illustrate the cycle (C) to produce electricity with new renewable energy provided by pump heat of compression, or other renewable energy or conventional heat sources. It is to be understood that the power plant cycle depicted on the figures uses light weighted dotted lines for the startup loop portion and heavier weighted solid lines for the power loop portion (FIGS. 1 and 1A). The P-H diagrams (FIGS. 2 and 2A) show the power plant cycle pressure, temperature, enthalpy, entropy, and phase conditions using CO₂.

### Startup Loop

The startup loop of the cycle consists of two flow streams. The first stream using heal input from pump HOC is initiated with CO₂ saturated liquid received in line 1 from tank T1 in storage and pumping area 50 to header connection C1, and then through line 1a, stop valve 1aSV, check valve CKV1, header connection C2, and line 2a to the inlet of pump P2 located at an elevation to provide a net positive suction head to the pump P2. The pressure is increased by P2 from T1 storage saturated pressure of 900 psia to a liquid supercritical pressure of about 6000 psia.

P2 outlet flow is routed through line 3a, header connection C3, line 4a, and indirect heat exchanger HX1; and then returned to P2 inlet through line 5a, flow control valve 5aCV and header connection C2. To initially provide more startup loop heat input before placing HX1 into service, HX1 is isolated by closing valve 5aCV and P2 outlet flow is recirculated from header connection C3 through recirculation line R and pressure control valve RCV to the P2 inlet. Valve RCV isenthalpically reduces the recirculation pressure from 6000 psia to near 1200 psia to decrease the supercritical liquid entropy entering P2 for a second isentropic pressure elevation to about 6000 psia, resulting in a higher enthalpy and temperature available for transferring heat to the power loop flowing through HX1, which is then placed into service by reversing the valve positions.

The second stream of CO₂ in the startup loop is routed from storage tank T1 to the inlet of pump P1 through line 1 and header connection C1. P1 elevates the pressure of subcooled liquid from 900 psia to a supercritical liquid pressure of about 1200 psia and directs the flow through line 2 and control valve 201CV to mixing header MH1 to combine with the flow leaving the turbine in the power loop. The total combined flow in the power loop leaving MH1 is routed through line 3 and indirect heat exchanger HX1 to absorb pump HOC input from the first startup stream. From HX1 the flow is routed through line 4 to the inlet of the compression apparatus. Accordingly, the startup loop charges the power loop with the required mass flow, heat input, and pressure for entering the compression apparatus.

### Power Loop

The compression apparatus includes a velocity choking device at the inlet, such as a choke valve (5CV), to control the critical pressure ratio and Mach 1 throat velocity to transition the entering stream velocity from subsonic to supersonic velocity. The velocity choking device outlet stream flows at supersonic velocity into a divergent duct DD that allows the velocity to increase more before flowing into the connected inlet of the SSWC to facilitate compression. The SSWC uses a cowi at the inlet to direct shock waves onto an angled surface, such as a cone, to optimize shock wave creation and compression. The cowl may be adjustable and the cone may have axially adjusted positions to increase the turndown range of the compression apparatus. The velocity choking device (5CV) and SSWC are conventional devices and form the compression apparatus with the connecting divergent duct (DD). A unique aspect of the compression apparatus is that it adapts a SSWC designed for compression of combustion air in moving supersonic aircraft engines to stationary compression service.

A unique aspect of the present invention is that the compression apparatus can also be used in other stationary technology applications such as carbon capture and storage (CCS), vehicle charging stations, CO₂ conditioning, CO₂ liquid manufacturing, gas turbine- generator combustion air technology, adapting supersonic aircraft engines to stationary power plants for a quick on-line schedule, or the like.

The power loop mass flow is increased until choke velocity is achieved in the throat of the 5CV at the minimum plug position to enable supersonic velocity to the SSWC to activate compression. In the power loop the pressure from P2 must be about 1200 psia and the enthalpy about 140 Btu/lb to avoid creating a saturated mixture or a low vapor temperature in the SSWC, since the 5CV reduces pressure to create choke velocity. The flow velocity in line 4 is subsonic (M<1) and the 5CV is controlled for a throat choke velocity (M=1) to transition the outlet to supersonic velocity (M>1). The compression apparatus should compress the vapor to the turbine set point pressure and temperature. Otherwise. one or more compression apparatus should be located in series downstream of the first compression apparatus. If a greater compression apparatus turndown range is required, one or more compression apparatus may be installed in parallel. Before the compression apparatus facilitates compression in the power loop, conventional compressor CC1 restores pressure to the cycle equivalent to the 5CV pressure reduction to control Mach 1 velocity. With 8CV closed, CC1 receives vapor from header connection C6 in line 11 through line B1 and control valve B1CV. From CC1, the vapor is returned to the power loop through line B2, control valve B2CV, and header connection C7. After the compression apparatus compresses vapor as designed, CC1 can be transitioned from service by opening 8CV and closing B1CV and B2CV.

In the event of a trip condition and the surge tank ST has insufficient volume of CO₂ to restart the cycle (C), CC1 would be placed back into service to restart the cycle. If the cycle is offline for an extended time period in which the CO₂ vapor is below conditions required for CC1, the cycle (C) should be evacuated through line EL and control valve ECV from MH2 to storage tank T3 in area 50 for reconditioning of the CO₂ vapor, which can include a compression apparatus.

### Alternative Startup Loop

The alternate startup loop is depicted in FIG. 1A and FIG. 2A. Pump P2 receives a subcooled liquid in line 1a from storage tank T1 operating at 800 psia saturation pressure. To provide pump HOC, P1 elevates the pressure to about 2000 psia and the outlet is routed to vapor separator S through line 2a and pressure reducing control valve 2aCV, which isenthalpically reduces the pressure to 810 psia to create a subcritical saturated mixture of about 20% vapor by weight. The vapor from vapor separator S is routed to a conventional compressor CC1 through line 3a and pressure reducing control valve 3aCV, which isentropically compresses the vapor to about 1200 psia and the outlet is routed to MH1 through line 4a, control valve 4aCV, and check valve CKV2 to combine with vapor leaving the turbine in the power loop. The total combined flow in the power loop leaving MH1 is routed through to indirect heat exchanger HX1 to absorb pump HOC input from the first startup stream. From HX1 the flow is routed through line 4 to the inlet of the compression apparatus. After which, the power loop remains the same. The separated saturated liquid is returned from separator S to storage tank T1 in line Sa through level control valve 5aCV. A unique aspect of the present invention is that the alternate startup loop charges the power loop with P1 and CC heats of compression, the initial pressure to the compression apparatus, and the mass flow. After the power loop is operating at a base load or full load, the startup loop is idle and can be placed on standby.

As further shown in FIG. 1A, the compression apparatus outlet flow is routed through line 6 and check valve CKV2 to one or more surge tanks ST and then through line 7, header connection C5, the turbine inlet control valve TICV, and to the turbine inlet. Another unique aspect of the present invention is that the turbine isentropically expands the vapor to produce electricity with the connected generator for distribution.

The vapor leaving the turbine is routed through line 8, emergency stop valve ESV, check valve CKV3, mixing header MH2, line 10, indirect heat exchanger HX2, line 11, header connection C6, control valve 8CV, and header connection C7 to combine with the startup loop vapor in mixing header MH1. The combined vapor in line 4 should be near 5CV inlet starting conditions, requiring an indirect heat exchanger HX2 to control the temperature of the vapor leaving the turbine. The power plant cycle C continues as described with the startup system adding heat input and mass flow until base load output from the cycle is achieved and is operating only on the power loop portion of the cycle. The startup portion of the cycle is then idle and can be placed into standby mode for load increases.

During a startup, as shown in FIGS. 1 and 1A, turbine bypass flow is routed from header connection C5 through line 9 and turbine bypass valve TBPV to mixing header MH2 and around the power loop until vapor conditions are suitable for introducing to the turbine through the TICV. After startup, the turbine bypass flow can be used in parallel with the turbine flow to provide more flow to the compression apparatus for increasing the compression control range.

The surge tank ST, as shown in FIGS. 1 and 1A, minimizes pressure fluctuations or pressure-temperature shocking conditions in the event of a pressure loss from the compression apparatus. For trip conditions, fast acting shutoff valve ESV in line 8 isolates the turbine with the surge tank ST to minimize turbine shocking.

The CO₂ to cool or heal the vapor leaving the turbine in HX2 is taken from either tank T1 or T2, depending on whether the temperature is lower or higher than required for the compression apparatus. The pressure leaving P_{HX} will be controlled based on the temperature leaving the turbine in order to provide about a 10° F. approach temperature in HX2 to the temperature of the vapor leaving the turbine, depending on whether the vapor should be cooled or heated. The coolant to HX2, as shown in FIGS. 1 and 1A, is taken through line 1ha, connection C8, control valve 1haCV, and line th from storage tank T2 operating at a saturation pressure of 575 psia to pump P_{HX} to elevate the subcooled liquid pressure to about 910 psia, which then flows through line 2h, control valve HX2CV and HX2. The coolant temperature is increased in HX2 so that the isenthalpic pressure reduction by control valve 3hCV creates a saturated liquid for routing to tank T1 through line 3h and control valve 3hCV. Another unique aspect of the present invention is that the described coolant circuitry cools the vapor leaving the turbine with excess heat available in T1 for plant usage, including temperature maintenance of area 50, reconditioning, plant heating, or dissipation to the environment. To heat the CO₂ vapor leaving the turbine, the vapor leaving the turbine is taken from tank T1 through line 1hb and control valve 1hbCV, connection C8, and line 1h to P_{HX}, in which the pressure is elevated from 900 psia to about 2000 psia to provide a 10° F. approach temperature to the vapor leaving the turbine. The heating CO₂ temperature is reduced in HX2 so that isenthalpic pressure reduction by control valve 3hCV creates a saturated liquid for return to tank T1 through line 3h and control valve 3hCV. Since P_{HX} consumes auxiliary power, the plant net power output will be reduced accordingly.

A further unique aspect of the present invention is that other renewable energy or conventional heat input sources may be used with the power plant cycle as depicted in FIGS. 1 and 1A:
The startup loop heat input to HX1 by the first stream depicted with light weighted solid lines using P2 (FIG. 1) pump HOC would be omitted.
An alternate heat input from other renewable energy or conventional sources is added to HX1 as noted in the text box with a dotted line boundary and dotted line arrow to HX1 (FIGS. 1 and 1A).
Otherwise, the cycle and description remain the same.
The alternate startup loop depicted in FIGS. 1A and 2A with P2 HOC would be modified by changing the location of HX1 from the power loop to the startup loop between P2 and separator S so that an alternate heat input from a current renewable energy or other conventional source can replace pump HOC as noted by FIG. 1A text box with a dotted line boundary and the dotted line arrows.
Otherwise, the cycle and description for the alternate startup loop remains the same.

With respect to FIG. 2, there is illustrated a graphical depiction of the calculation values and results for the sample calculation below estimating full load net power production, Pn:

### Assumptions:

T1 stores CO₂ at 900 psia-75° F. saturation conditions
Full load supercritical vapor mass flow to turbine, rh1=6.0×10⁶ lb/hr
Since the startup loop is on standby and P1 and P2 are not operating, assume that conditions entering the power loop in line 4 are as follows:
[symbol] P=1200 psia
[symbol] T=120° F.
[symbol] h=140 Btu/lb

Critical pressure ratio calculation for choked flow with CO₂ vapor for supersonic vapor velocity leaving the VCV:
Pc/Po=[2/(γ+1)]^{γ/γ-1}
Where, Pc=critical pressure
Po=upstream static pressure
γ=specific heat ratio=1.27 in the cycle operating temperature range
Pc/Po=[2/(2.27)]^{4.7}=0.55
Pressure reduction by 5CV=0.55×1200 =660 psia

Therefore, the 5CV reduces the pressure to 660 psia at a temperature of 65° F. and entropy of 0.220 Btu/lb-° F. to control choke velocity and transition the subsonic vapor velocity to supersonic velocity. The CO₂ does not enter the subcritical mixture phase and the temperature is acceptable to enter the SSWC at this pressure and enthalpy condition.

Conditions resulting with SSWC non-isentropic compression from 660 psia to 6000 psia
[symbol] h=178 Btu/lb
[symbol] T=365° F.
[symbol] Entropy, S=0.235 Btu/lb-° F.
Turbine efficiency, η_{T}=85%
Generator efficiency, η_{G}32 98%

The turbine isentropically expands the CO₂ from a pressure of 6000 psia and enthalpy of 178 Btu/lb to pressure of 1200 psia and enthalpy of 142 Btu/lb, resulting in an enthalpy differential Δh_{T} of 38 Btu/lb for work.
Net plant power production, Pn=MW_{T}−P_{HX}
   where, MW_{T} is turbine-generator gross power production and P_{HX} is auxiliary
   power consumed by the coolant loop pump (P_{HX}).
Turbine-generator power production in megawatts, MW_{T}:
MW_{T}=(rh1×Δh_{T}×η_{T}×η_{G})/3412×10³ MW/Btu=(6.0×10⁶ lb/hr×38×0.85×0.98)/3412×10³
MW_{T}=55.66

The startup loop is in standby mode and P1 and P2 are not consuming auxiliary power.

To generally estimate the amount of coolant loop pump P_{HX} power consumption:
Power loop enthalpy reduction leaving turbine, Δh_{PL}=158−140=18 Btu/lb
Assume the coolant is taken from a storage tank operating at a saturated pressure of 550 psia and the subcooled liquid is pumped to 910 psia. The enthalpy increases in HX2 and transitions back to a saturated liquid at 900 psia after isenthalpic pressure reduction to 550 psia,
   Δh_{LC}=70−46=24 Btu/lb.
Coolant mass flow, \dot{m}_{LC}
   HX2 heat balance:
      (\dot{m}_{LC}×Δh_{LC})=Δh_{PL}×\dot{m}1
      24 \dot{m}_{LC}=6.0×10⁶×18
      24 \dot{m}_{LC}=108×10⁶
      \dot{m}_{LC}=4.5×10⁶ lb/hr
BHP=(Q×H×SG)/(3960×ηₚ), where
Q=water flow in gallons per minute, gpm
Q=\dot{m}_{LC}/(8.02×density)=4.5×10⁶/(8.02×62.4)=8,992 gpm water
H=head, ft water=144/62.4×(Pd−Pi)=2.31×(910−585)=750.75 ft
BHP=(8,992×750.75×0.89)/(3960×0.9)=1685.8
Average CO₂ density=55.5 (specific gravity, SG=55.5/62.4=0.89)
η_{P}=assumed pump efficiency=90%
P_{HX}, MW=1685.8×0.746 KW/hp=1,257.6 kW=1.28 MW
P_{HX}, assuming a motor efficiency of 97%=1.30 MW

The saturated liquid coolant leaving HX2 is returned to a storage tank operating at a saturation pressure of 900 psia. Extra heat may be dissipated to the environment from the storage tank unless it is used to manage storage area 50 heat requirements, used in the cycle, or plant heating.

Therefore, Pn=MW_{T}−P_{HX}=55.66−1.30=54.4 MW

Calculations to demonstrate capabilities of the startup loop to charge the power loop with pump heat of compression input:
T1 stores CO₂ at 900 psia-75° F. saturated conditions
P1 elevates the pressure of the second stream (S1) from T1 pressure of 900 psia to the following conditions entering the power loop and HX1:
   [symbol] rh1=2.0×10€ lb/hr (assumed starting flow)
   [symbol] P=1200 psia
   [symbol] T=85° F.
   [symbol] h=70 Btu/lb
The startup CO₂ conditions leaving HX1 in line 4 to the power loop compression apparatus at a pressure of 1200 psia, as assumed in the Pn calculation above:
   [symbol] h=140 Btu/lb
   [symbol] T=120° F.
   [symbol] Entropy, S=0.230 Btu/lb-° F.

Therefore, Δh_{S2}=140−70=70 Btu/lb
P2 elevates the pressure of the first stream (S1) from T1 pressure of 900 psia to the following conditions:
   [symbol] Pressure, P=6000 psia
   [symbol] Temperature, T=142° F.
   [symbol] Enthalpy, h=82 Btu/lb

To increase the startup heat input with HX1 isolated, the pressure of S1 is reduced by the RCV at constant enthalpy from 6000 psia to near 1200 psia to decrease the entropy, and then the pressure is isentropically elevated a second time by P2 to near 6000 psia, resulting in an enthalpy of 105 Btu/lb and temperature of 190° F.
Since S1 leaving HX1 is 140° F., and assuming a 10° F. approach temperature, S2 temperature leaving HX1 is 150° F. with an h=85.
   Therefore, Δh_{S1}=105−85=20 Btu/lb
HX1 heat balance:
\dot{m}1×Δh_{S2}=\dot{m}2×Δh_{S1}
\dot{m}2=(2.0×109 lb/hr×70 Btu/lb)/20 Btu/lb=7.0×109 lb/hr

Therefore, the startup loop pump HOC for charging the power loop with heat input is demonstrated.

The mass flow from the startup loop is increased to achieve the minimum mass flow of the SSWC required to facilitate compression; thereby, setting the minimum base load of operation. Since the vapor conditions entering the turbine bypass are now at suitable conditions for entering the turbine, the turbine-generator set may be placed into service by transitioning the turbine bypass out of service. With the vapor leaving the turbine bypass, and then the turbine, and HX2 in service, the startup loop heat input to HX1 can be controlled accordingly in concert with the vapor temperature leaving HX2 to control temperature entering the compression apparatus.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper.” “horizontal,” “vertical,” “above.” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

The specific methods and compositions described herein are representative of preferred embodiments and are exemplary and not intended as limitations on the scope of the invention. Other objects, aspects, and embodiments will occur to those skilled in the art upon consideration of this specification and are encompassed within the spirit of the invention. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other modifications and implementations will occur to those skilled in the art without departing from the spirit and the scope of the invention. Accordingly, the description hereinabove is not intended to limit the invention.

I claim:

1. A method of using a renewable energy power plant cycle, wherein the method comprises:
operating a startup loop, wherein the startup loop includes a plurality of flow streams of liquid carbon dioxide (CO₂) which provides a mass flow, a starting pressure, and heat input from pump heat of compression to a power loop that is operatively connected to the startup loop, and wherein startup loop continues increasing the mass flow to a vapor compression apparatus located within the power loop until compression is facilitated within the vapor compression apparatus and a desired base load is achieved by the cycle; and
operating the power loop, wherein the power loop comprises;
operating the vapor compression apparatus, wherein the vapor compression apparatus includes a velocity choking device located upstream of a supersonic shock wave compressor (SSWC) wherein the velocity choking device transitions CO₂ flowing at a subsonic velocity to a supersonic velocity entering the SSWC,
operating a surge tank, wherein the surge tank is operatively connected to the vapor compression apparatus such that the surge tank maintains a sufficient volume of CO₂ vapor to minimize pressure fluctuations and minimizes large pressure and thermal shocks to a turbine, and
operating the turbine, wherein the turbine is operatively connected to the surge tank such that the turbine isentropically expands the CO₂ vapor to produce electricity with a shaft-connected generator, and wherein the CO₂ vapor leaving the turbine is not condensed.

2. The method, according to claim 1, wherein the plurality of flow streams of liquid carbon dioxide (CO₂) further comprises:
providing a first flow stream by operating a first pump to receive liquid CO₂ from a first tank storing CO₂ at saturation pressure, such that the first pump then elevates a pressure of the liquid CO₂ to a supercritical pressure liquid to produce HOC for heat transfer to the power loop in a first indirect heat exchanger located upstream of the compression apparatus.

3. The method, according to claim 2, wherein the plurality of flow streams of liquid carbon dioxide (CO₂) further comprises:
providing a second flow stream by operating a second pump to receive liquid CO₂ from the first tank, such that the second pump elevates the pressure of the liquid CO₂ to a supercritical pressure just above a critical pressure for entering into the power loop and the indirect heat exchanger to absorb heat from the first flow stream in order to provide a preliminary starting mass flow, pressure, and temperature to the vapor compression apparatus.

4. The method, according to claim 1, wherein operating the vapor compression apparatus further comprises:
operating a choke valve as the velocity choking device to control a critical pressure ratio and a Mach 1 throat velocity to transition the liquid CO₂ flowing at a subsonic velocity to a supersonic velocity entering the SSWC in order to simulate an air speed greater than Mach 1.

5. The method, according to claim 3, wherein the method further comprises:
routing the CO₂ vapor leaving the turbine through a second indirect heat exchanger for controlling the temperature of the CO₂ vapor; and
routing the CO₂ vapor to a first mixing header to recombine the CO₂ vapor with the second flow stream.

6. The method, according to claim 1, wherein operating the power loop further comprises:
operating a turbine bypass, wherein the turbine bypass is operatively connected between the turbine and a second mixing header such that the turbine bypass ensures that CO₂ vapor does not enter the turbine until desired CO₂ vapor conditions at an inlet to the turbine are reached.

7. The method, according to claim 5, wherein operating the power loop further comprises:
operating a coolant loop to reduce a temperature of the CO₂ vapor leaving the turbine, wherein the operating the coolant loop comprises;
operating a third pump to receive liquid CO₂ from a second tank storing CO₂ at saturation pressure,
routing the liquid CO₂ to the second indirect heat exchanger.
operating the second indirect heat exchanger to transform the CO₂ liquid to a saturated liquid CO₂, and
routing the saturated liquid CO₂ to the first tank,
operating a heating loop to increase a temperature of the CO₂ vapor leaving the turbine, wherein operating the heating loop comprises;
operating the third pump to receive liquid CO₂ from the first tank storing liquid CO₂ at saturation pressure and elevating a pressure and a temperature of the liquid CO₂,
routing the liquid CO₂ to the second indirect heat exchanger.
operating the second indirect heat exchanger to reduce the temperature of the heated liquid CO₂ so that the valve reduces the pressure isenthalpically to transform the CO₂ liquid to a saturated liquid CO₂, and
routing the saturated liquid CO₂ to the first tank.

8. A method of using a renewable energy power plant cycle, wherein the method comprises:
operating a startup loop, wherein the startup loop includes a flow stream of liquid carbon dioxide (CO₂) which provides a mass flow, a starting pressure, and heat input from pump heat of compression to a power loop that is operatively connected to the startup loop, and wherein startup loop continues increasing the mass flow to a vapor compression apparatus located within the power loop until compression is facilitated within the vapor compression apparatus and a desired base load is achieved by the cycle; and
operating the power loop, wherein the power loop comprises;
operating the vapor compression apparatus, wherein the vapor compression apparatus includes a velocity choking device located upstream of a supersonic shock wave compressor (SSWC) wherein the velocity choking device transitions CO₂ flowing at a subsonic velocity to a supersonic velocity entering the SSWC,
operating a surge tank, wherein the surge tank is operatively connected to the vapor compression apparatus such that the surge tank maintains a sufficient volume of CO₂ vapor to minimize pressure fluctuations and minimizes large pressure and thermal shocks to a turbine, and
operating the turbine, wherein the turbine is operatively connected to the surge tank such that the turbine isentropically expands the CO₂ vapor to produce electricity with a shaft-connected generator, and wherein the CO₂ vapor leaving the turbine is not condensed.

9. The method, according to claim 8, wherein the flow stream of liquid carbon dioxide (CO₂) further comprises:
providing a flow stream by operating a first pump to receive liquid CO₂ from a first storage tank storing CO₂ at saturation pressure, such that the first pump then elevates a pressure of the liquid CO₂ to a supercritical pressure liquid to produce HOC for heat transfer;
providing a first heat exchanger, wherein the first exchanger absorbs pump HOC input from the flow stream;
routing the pressurized liquid CO₂ to a valve, wherein the valve isenthalpically reduces the pressure of the liquid CO₂ to create a subcritical saturated mixture of CO₂ vapor and liquid;
routing the saturated mixture to a vapor separator to separate the vapor;
routing CO₂ vapor from the vapor separator to a compressor, wherein the CO₂ vapor is isentropically compressed;
routing the compressed CO₂ vapor to a mixing header; and
retuming the CO₂ liquid from the vapor separator to the first storage tank.

10. The method, according to claim 8, wherein operating the vapor compression apparatus further comprises:
operating a choke valve as the velocity choking device to control a critical pressure ratio and a Mach 1 throat velocity to transition the liquid CO₂ flowing at a subsonic velocity to a supersonic velocity entering the SSWC in order to simulate an air speed greater than Mach 1.

11. The method, according to claim 9, wherein the method further comprises:
routing the CO₂ vapor leaving the turbine through a second indirect heat exchanger for controlling the temperature of the CO₂ vapor; and
routing the CO₂ vapor to a first mixing header to recombine the CO₂ vapor with the flow stream.

12. The method, according to claim 8, wherein the operating the power loop further comprises:
operating a turbine bypass, wherein the turbine bypass is operatively connected between the turbine and a second mixing header such that the turbine bypass ensures that CO₂ vapor does not enter the turbine until desired CO₂ vapor conditions at an inlet to the turbine are reached.

13. The method, according to claim 11, wherein operating the power loop further comprises:
operating a coolant loop to control a temperature of the CO₂ vapor leaving the turbine, wherein operating the coolant loop comprises;
operating a third pump to receive liquid CO₂ from a second tank storing COz at saturation pressure,
routing the liquid CO₂ to the second indirect heat exchanger,
operating the second indirect heat exchanger to increase the temperature of the coolant so that a valve reduces the pressure isenthalpically to transform the CO₂ subcooled liquid to a saturated liquid,
routing the saturated liquid CO₂ to the first tank,
operating a heating loop to increase a temperature of the CO₂ vapor leaving the turbine, wherein operating the heating loop comprises;
operating the third pump to receive liquid CO₂ from the first tank storing liquid CO₂ at saturation pressure and elevating a pressure and a temperature of the liquid CO₂,
routing the liquid CO₂ to the second indirect heat exchanger,
operating the second indirect heat exchanger to reduce the temperature of the heated liquid CO₂ so that the valve reduces the pressure isenthalpically to transform the CO₂ liquid to a saturated liquid CO₂, and
routing the saturated liquid CO₂ to the first tank.

14. A renewable energy power plant, comprising:
a startup loop, wherein the startup loop includes a plurality of flow streams of liquid carbon dioxide (CO₂) which provides a mass flow, a starting pressure, and heat input from pump heat of compression to a power loop that is operatively connected to the startup loop, and wherein the startup loop continues increasing the mass flow to a vapor compression apparatus located within the power loop until compression is facilitated within the vapor compression apparatus and a desired base load is achieved by the cycle; and
the power loop, wherein the power loop comprises;
a vapor compression apparatus, wherein the vapor compression apparatus includes a velocity choking device located upstream of a supersonic shock wave compressor (SSWC) wherein the velocity choking device transitions CO₂ flowing at a subsonic velocity to a supersonic velocity entering the SSWC,
a surge tank, wherein the surge tank is operatively connected to the vapor compression apparatus such that the surge tank maintains a sufficient volume of CO₂ vapor to minimize pressure fluctuations and minimizes large pressure and thermal shocks to a turbine, and
wherein the turbine is operatively connected to the surge tank such that the turbine isentropically expands the CO₂ vapor to produce electricity with a shaft-connected generator, and wherein the CO₂ vapor leaving the turbine is not condensed

15. The renewable energy power plant, according to claim 14, wherein the plurality of flow streams of liquid carbon dioxide (CO₂) further comprises:
a first flow stream, wherein the first flow stream includes a first pump to receive liquid CO₂ from a first tank storing CO₂ at saturation pressure, such that the first pump then elevates a pressure of the liquid CO₂ to a supercritical pressure liquid to produce HOC for heat transfer to the power loop in a first indirect heat exchanger located upstream of the compression apparatus.

16. The renewable energy power plant, according to claim 15, wherein the plurality of flow streams of liquid carbon dioxide (CO₂) further comprises:
a second flow stream, wherein the second flow stream includes a second pump to receive liquid CO₂ from the first tank, such that the second pump elevates the pressure of the liquid CO₂ to a supercritical pressure just above a critical pressure for entering into the power loop and the indirect heat exchanger to absorb heat from the first flow stream in order to provide a preliminary starting mass flow, pressure, and temperature to the vapor compression apparatus.

17. The renewable energy power plant, according to claim 14, wherein the vapor compression apparatus further comprises:
a choke valve, wherein the choke valve controls a critical pressure ratio and a Mach 1 throat velocity to transition the liquid CO₂ flowing at a subsonic velocity to a supersonic velocity entering the SSWC in order to simulate an air speed greater than Mach 1.

18. The renewable energy power plant, according to claim 16, wherein the renewable energy power plant further comprises:
a second indirect heat exchanger for controlling the temperature of the CO₂ vapor; and
a first mixing header to recombine the CO₂ vapor with the second flow stream.

19. The renewable energy power plant, according to claim 14, wherein the power loop further comprises:
a turbine bypass, wherein the turbine bypass is operatively connected between the turbine and a second mixing header such that the turbine bypass ensures that CO₂ vapor does not enter the turbine until desired CO₂ vapor conditions at an inlet to the turbine are reached.

20. The renewable energy power plant, according to claim 18, wherein the power loop further comprises:
a coolant loop to reduce a temperature of the CO₂ vapor leaving the turbine, wherein the coolant loop comprises;
a third pump to receive liquid CO₂ from a second tank storing CO₂ at saturation pressure,
wherein the third pump is operatively connected to the second indirect heat exchanger, and
wherein the second indirect heat exchanger is operatively connected to the first tank.
